(19) United States
(12) Patent Application Publication
(10) Pub. No.: US 2018/0349937 A1
(43) Pub. Date: Dec. 6, 2018

(54) ANALYSIS PLATFORM SYSTEM AND METHOD

(71) Applicant: Melete Inc., Boston, MA (US)

(72) Inventor: WILFRIED R. VANHONACKER, Paulinet (FR)

(21) Appl. No.: 15/995,882

(22) Filed: Jun. 1, 2018

Related U.S. Application Data
(60) Provisional application No. 62/513,713, filed on Jun. 1, 2017.

(51) Int. Cl. G06Q 30/02; G06Q 10/06

(52) U.S. Cl. CPC G06Q 30/0217; G06Q 10/063; G06Q 30/0201

(57) ABSTRACT

A computer-implemented method, computer program product and computing system for receiving a participant report concerning an analysis project from each of a plurality of platform participants, thus defining a plurality of participant reports. Each of the plurality of platform participants is compensated based, at least in part, upon their received participant report.

### RELATED APPLICATION(S)

This application claims the benefit of U.S. Provisional Application No. 62/513,713, filed on 1 Jun. 2017, the entire contents of which are incorporated herein by reference.

### TECHNICAL FIELD

This disclosure relates to analysis platforms and, more particularly, to analysis platforms for receiving analysis from a plurality of participants.

### BACKGROUND

Often and during the course of business, parties need opinion information from a plurality of entities For example, a company may need opinion information from a plurality of job candidates seeking to be hired, an employer may need opinion information from a plurality of employees seeking to be promoted; and a business may need opinion information from a plurality of business experts.

Unfortunately and once this opinion information is received, the processing of such opinion information may prove difficult. For example, the party seeking the opinion information may need to identify a specific result or a specific trend embedded within the opinion information received. Unfortunately and especially when the plurality of entities providing opinion information is quite large, the process of identifying the specific result or the specific trend embedded within the opinion information received may prove to be daunting.

### SUMMARY OF DISCLOSURE

Compensation System

In one implementation, a computer-implemented method is executed on a computing device and includes receiving a participant report concerning an analysis project from each of a plurality of platform participants, thus defining a plurality of participant reports. Each of the plurality of platform participants is compensated based, at least in part, upon their received participant report.

One or more of the following features may be included. Each of the plurality of platform participants is graded based, at least in part, upon their received participant report. Compensating each of the plurality of platform participants based, at least in part, upon their received participant report may include compensating a specific platform participant based, at least in part, upon the grading of the specific platform participant. Compensating a specific platform participant based, at least in part, upon the grading of the specific platform participant may include providing a pro rata portion of a compensation pool associated with the analysis project to the specific platform participant based, at least in part, upon the grading of the specific platform participant. Compensating each of the plurality of platform participants based, at least in part, upon their received participant report may include compensating a specific platform participant based, at least in part, upon the grading of other platform participants. Compensating a specific platform participant based, at least in part, upon the grading of other platform participant may include providing a pro rata portion of a compensation pool associated with the analysis project to the specific platform participant based, at least in part, upon the grading of other platform participants. The plurality of participant reports may be consolidated to form an analysis project report. The analysis project report may be provided to a client. The plurality of platform participants may include one or more of: a plurality of experts; a plurality of applicants; a plurality of employees; and a plurality of candidates.

In another implementation, a computer program product resides on a computer readable medium and has a plurality of instructions stored on it. When executed by a processor, the instructions cause the processor to perform operations including receiving a participant report concerning an analysis project from each of a plurality of platform participants, thus defining a plurality of participant reports. Each of the plurality of platform participants is compensated based, at least in part, upon their received participant report.

One or more of the following features may be included. Each of the plurality of platform participants is graded based, at least in part, upon their received participant report. Compensating each of the plurality of platform participants based, at least in part, upon their received participant report may include compensating a specific platform participant based, at least in part, upon the grading of the specific platform participant. Compensating a specific platform participant based, at least in part, upon the grading of the specific platform participant may include providing a pro rata portion of a compensation pool associated with the analysis project to the specific platform participant based, at least in part, upon the grading of the specific platform participant. Compensating each of the plurality of platform participants based, at least in part, upon their received participant report may include compensating a specific platform participant based, at least in part, upon the grading of other platform participants. Compensating a specific platform participant based, at least in part, upon the grading of other platform participant may include providing a pro rata portion of a compensation pool associated with the analysis project to the specific platform participant based, at least in part, upon the grading of other platform participants. The plurality of participant reports may be consolidated to form an analysis project report. The analysis project report may be provided to a client. The plurality of platform participants may include one or more of: a plurality of experts; a plurality of applicants; a plurality of employees; and a plurality of candidates.

In another implementation, a computing system includes a processor and memory is configured to perform operations receiving a participant report concerning an analysis project from each of a plurality of platform participants, thus defining a plurality of participant reports. Each of the plurality of platform participants is compensated based, at least in part, upon their received participant report.

One or more of the following features may be included. Each of the plurality of platform participants is graded based, at least in part, upon their received participant report. Compensating each of the plurality of platform participants based, at least in part, upon their received participant report may include compensating a specific platform participant based, at least in part, upon the grading of the specific platform participant. Compensating a specific platform participant based, at least in part, upon the grading of the specific platform participant may include providing a pro rata portion of a compensation pool associated with the analysis project to the specific platform participant based, at least in part, upon the grading of the specific platform participant. Compensating each of the plurality of platform participants based, at least in part, upon their received participant report may include compensating a specific platform participant based, at least in part, upon the grading of other platform participants. Compensating a specific platform participant based, at least in part, upon the grading of other platform participant may include providing a pro rata portion of a compensation pool associated with the analysis project to the specific platform participant based, at least in part, upon the grading of other platform participants. The plurality of participant reports may be consolidated to form an analysis project report. The analysis project report may be provided to a client. The plurality of platform participants may include one or more of: a plurality of experts; a plurality of applicants; a plurality of employees; and a plurality of candidates.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an analysis process according to an embodiment of the present disclosure;

FIG. 2 is a flowchart of one implementation of the analysis process of FIG. 1 according to an embodiment of the present disclosure; and

FIG. 3 is a flowchart of another implementation of the analysis process of FIG. 1 according to an embodiment of the present disclosure.

Like reference symbols in the various drawings indicate like elements.

### DETAILED DESCRIPTION OF THE PREFERRED EMBODIMENTS

System Overview

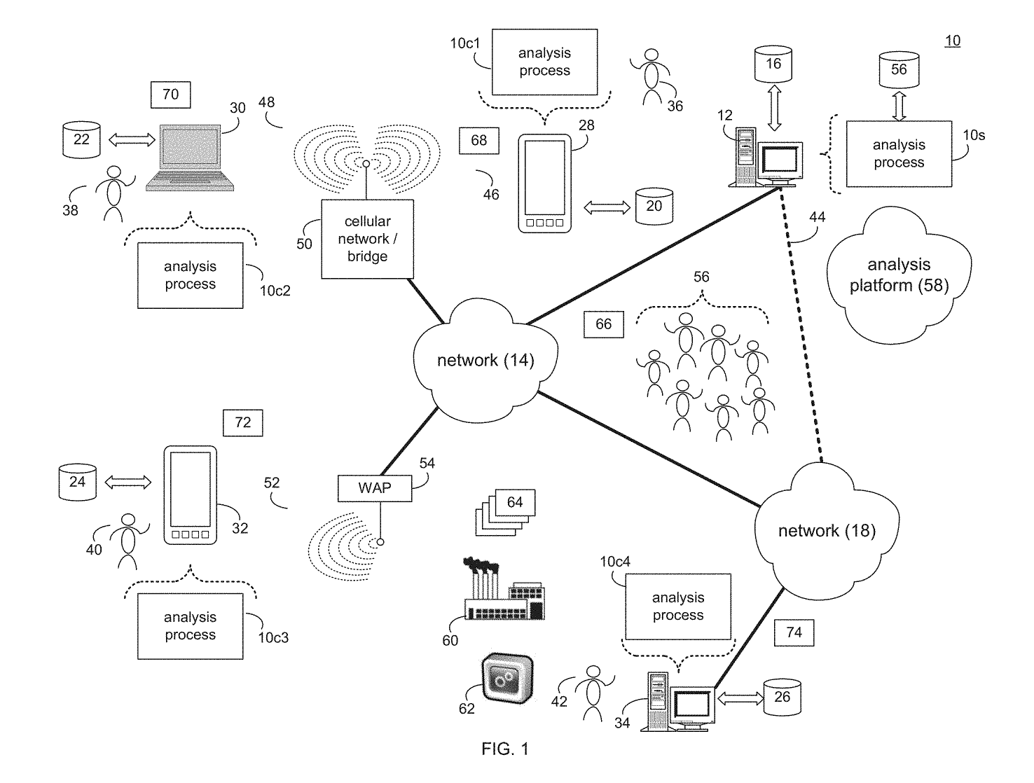

Referring to FIG. 1, there is shown analysis process 10. Analysis process 10 may be implemented as a server-side process, a client-side process, or a hybrid server-side/client-side process. For example, analysis process 10 may be implemented as a purely server-side process via analysis process 10s. Alternatively, analysis process 10 may be implemented as a purely client-side process via one or more of client-side process 10c1, client-side process 10c2, client-side process 10c3, and client-side process 10c4. Alternatively still, analysis process 10 may be implemented as a hybrid server-side/client-side process via data process 10s in combination with one or more of client-side process 10c1, client-side process 10c2, client-side process 10c3, and client-side process 10c4. Accordingly, analysis process 10 as used in this disclosure may include any combination of analysis process 10s, client-side process 10c1, client-side process 10c2, client-side process 10c3, and client-side process 10c4.

Analysis process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of analysis process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a user interface, or a specialized application (e.g., an application running on e.g., the Android™ platform or the iOS™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access analysis process 10 directly through network 14 or through secondary network 18. Further, analysis process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Analysis Platform

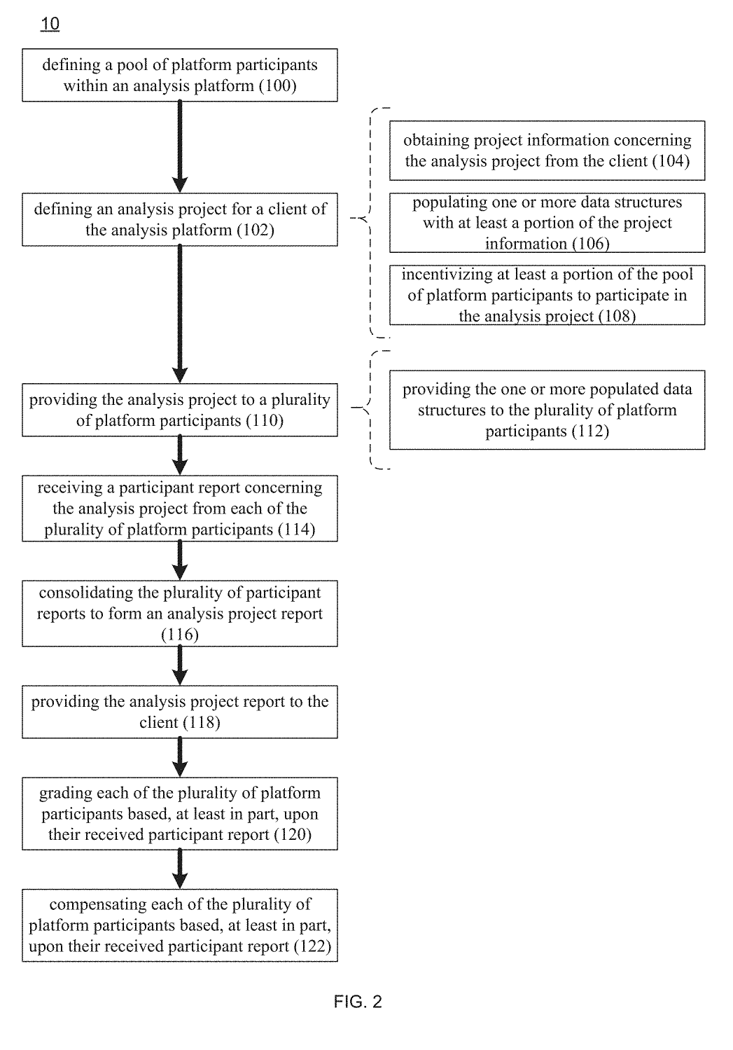

Referring also to FIG. 2, analysis process 10 may define 100 a pool of platform participants (e.g., pool of platform participants 56) within an analysis platform (e.g., analysis platform 58). When defining 100 the pool of platform participants (e.g., pool of platform participants 56), the individual members of pool of platform participants 56 may be vetted and/or qualified (e.g., via academics and/or experience) prior to them being included within/added to pool of platform participants 56. Analysis platform 58 may be configured to allow a client of analysis platform 58 to obtain opinion information from one or more members of pool of platform participants 56.

Examples of pool of platform participants 56 may include but is not limited to one or more of: a plurality of experts; a plurality of applicants; a plurality of employees; and a plurality of candidates. For example, the client of analysis platform 58 may be a company that has a job opening that needs to be filled and the pool of platform participants 56 may be a plurality of job applicants that are applying for the job opening, wherein the opinion information sought may be information indicative of the qualifications of the job applicants that are applying for the job opening. Alternatively, the client of analysis platform 58 may be a company that has an internal management opening that needs to be filled and the pool of platform participants 56 may be a plurality of current employees that are applying for the internal management opening, wherein the opinion information sought may be information indicative of the qualifications of the current employees that are applying for the internal management opening. Further, the client of analysis platform 58 may be a company that is launching a new product in a specific industry and the pool of platform participants 56 may be a plurality of experts in the specific industry, wherein the opinion information sought may be information concerning the e.g., appropriate pricing concerning this new product.

For the following example and for illustrative purposes, assume that the client (e.g., user 42) is a representative of a company (e.g., company 60) that wishes to produce widget 62 and introduce it into the widget market. Assume that this is a new type of widget and, therefore, there are no direct comparables in the market. Accordingly, company 60 and user 42 may not know how to price widget 62 when entering the widget market. Accordingly, client 42 (as a representative of company 60) may access analysis platform 58 so that they may utilize analysis process 10 to obtain some guidance concerning the proposed pricing of widget 62.

Accordingly and upon the client (e.g., user 42 and company 60) accessing analysis process 10, analysis process 10 may define 102 an analysis project for the client (e.g., user 42 and company 60) of analysis platform 58. For example and when defining 102 an analysis project for the client (e.g., user 42 and company 60) of analysis platform 58, analysis process 10 may obtain 104 project information concerning the analysis project from the client (e.g., user 42 and company 60) and may populate 106 one or more data structures (e.g., data frames 64) with at least a portion of the project information, thus generating one or more populated data structures (e.g., one or more populated data frames)

Typically, the quantity of data structures (e.g., frames 64) populated 106 by analysis process 10 may vary depending upon the complexity of the analysis project defined. For example, simple analysis projects (e.g., setting a resale price in a first country for a known product) may require a single data structure (e.g., frame 64); where a more complex project (e.g., determining the resale price in a first country for a known product that is going to be manufactured in a second country) may require two data structures (e.g., frames 64); while a complex project (e.g., determining the resale price in a first country for a new product (i.e., no direct comparables) that is going to be manufactured in a second country) may require several data structures (e.g., frames 64).

Assume for this example that the analysis project (e.g., analysis project 66) defined by user 42 is a simple one. For example, assume that company 60 is planning on manufacturing widget 62 in the United States and reselling the same in the American market . . . but user 42 does not know where to set the retail price (MSRP) for widget 62. Assume that widget 62 is not a new product but does not have any direct comparables.

Accordingly and upon the client (e.g., user 42 and company 60) accessing analysis process 10, analysis process 10 may define 102 analysis project 66 of widget 62 for the client (e.g., user 42 and company 60). For example, analysis process 10 may obtain 104 project information from the client (e.g., user 42 and company 60) and may populate 106 (in this case) a data structure (e.g., data frame 64) with at least a portion of the project information, thus generating one or more populated data structures (e.g., one or more populated data frames). Assume for this example that when defining 102 analysis project 66 for widget 62, user 42 may define the information sought (e.g., the retail price (MSRP) for widget 62) and may provide known information, examples of which may include but are not limited to the size of widget 62, the weight of widget 62, the material type of widget 62, the functionality of widget 62, the quantity to be manufactured of widget 62, and the expected cost of manufacturing widget 62.

As could be imagined, the project information obtained from the client (e.g., user 42 and company 60) concerning analysis project 66 (e.g., setting the MSRP for widget 62) may include one or more variables. For example, the information obtained from the client (e.g., user 42 and company 60) may be as follows:

| | |
|---|---|
| Product: | Widget 62 |
| Additional Information: | Mechanical drawings and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $18-$20 |
| Project Question: | Suggested MSRP |

Accordingly and as shown above, the client (e.g., user 42 and company 60) is not sure of the cost of manufacturing widget 62 in the United States, as they are only able to limit it to a range (e.g., $18-$20). Therefore, the information obtained from the client (e.g., user 42 and company 60) and defined within the data structure (e.g., frame 64) may include/define such a range.

Continuing with the above-described example, when defining 102 an analysis project (e.g., analysis project 66) for the client (e.g., user 42 and company 60) of analysis platform 58, analysis process 10 may incentivize 108 at least a portion of pool of platform participants 56 to participate in analysis project 66.

For example, a compensation pool may be defined for analysis project 66 that may be paid out to successful participants, wherein the specific compensation received by each successful participant may vary depending upon the quality of their response to analysis project 66. For example, if $1,000 is defined as the compensation pool available to (and split amongst) successful participants, a successful participant may receive (in this example) up to $1,000 (if they are the only successful participant) or may receive a smaller portion of the $1,000 (if they are only partially successful or there are multiple successful participants). The manner in which participants are compensated from this compensation pool is discussed below in greater detail.

Accordingly and when incentivizing 108 at least a portion of pool of platform participants 56 to participate in analysis project 66, analysis process 10 may inform pool of participants 56 that they may earn up to $1,000 (in this example) to incentivize them to participate in (and work on) analysis project 66. In the event that specific requirements are placed upon the participants on analysis project 66, the pool of platform participants 56 may be filtered so that analysis project 66 is only offered to a sub-portion of pool of platform participants 56. For example, if widget 62 is an airplane part, user 42/company 60 may wish that analysis project 66 is only offered to participants within the aviation industry.

For illustrative purposes and to make the example manageable, assume that analysis project 66 was presented to pool of platform participants 56 and three participants agreed to work on the project, namely users 36, 38, 40. Analysis process 10 may then provide 110 analysis project 66 to the plurality of platform participants (e.g., users 36, 38, 40), chosen from the pool of platform participants 56. When providing 110 analysis project 66 to a plurality of platform participants (e.g., users 36, 38, 40), analysis process 10 may provide 112 the one or more populated data structures (e.g., data frames 64) to the plurality of platform participants (e.g., users 36, 38, 40).

In the event that analysis project 66 was defined without any variables (e.g., the cost of manufacturing widget 62 was defined by the client as $19), each of the plurality of platform participants (e.g., users 36, 38, 40) may receive an identical version of analysis project 66. For example and in a situation in which the client defined the cost of manufacturing widget 62 as $19, each of users 36, 38, 40 may receive the following information:

| Product: | Widget 62 |
|---|---|
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $19 |
| Project Question: | Suggested MSRP |

Alternatively and in the event that analysis project 66 was defined with a variable (e.g., the cost of manufacturing widget 62 was defined by the client as $18-$20), each of the plurality of platform participants (e.g., users 36, 38, 40) may receive differing versions of analysis project 66 that assign differing values to the variable(s). For example and in a situation in which the client defined the cost of manufacturing widget 62 as $18-$20, each of users 36, 38, 40 may receive differing information.

For example, user 36 may receive:

| Product: | Widget 62 |
|---|---|
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $18 |
| Project Question: | Suggested MSRP |

Further, user 38 may receive:

| Product: | Widget 62 |
|---|---|
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $19 |
| Project Question: | Suggested MSRP |

Additionally, user 40 may receive:

| Product: | Widget 62 |
|---|---|
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $20 |
| Project Question: | Suggested MSRP |

Upon receiving the above-described information, users 36, 38, 40 may process the information received to determine a suggested MSRP for widget 62. Users 36, 38, 40 may then provide the requested information to analysis process 10. For example, analysis process 10 may receive 114 a participant report concerning analysis project 66 from each of the plurality of platform participants (e.g., user 36, 38, 40), thus defining a plurality of participant reports. For example, analysis process 10 may receive 114: participant report 68 from user 36, participant report 70 from user 38, and participant report 72 from user 40, wherein analysis process 10 may consolidate 116 the plurality of participant reports (e.g., participant reports 68, 70, 72) to form an analysis project report (e.g., analysis project report 74).

In this particular example, analysis project report 74 may provide three pieces of information, namely: a suggested MSRP for widget 62 from user 36 for when widget 62 has a manufacturing cost of $18; a suggested MSRP for widget 62 from user 38 for when widget 62 has a manufacturing cost of $19; and a suggested MSRP for widget 62 from user 40 for when widget 62 has a manufacturing cost of $20. Assume that the MSRP suggested by user 36 within participant report 68 for widget 62 having a manufacturing cost of $18 is $40; that the MSRP suggested by user 38 within participant report 70 for widget 62 having a manufacturing cost of $19 is $45; and the MSRP suggested by user 40 within participant report 72 for widget 62 having a manufacturing cost of $20 is $43.

Once analysis process 10 consolidates 116 the plurality of participant reports (e.g., participant reports 68, 70, 72) to form analysis project report 74, analysis process 10 may provide 118 analysis project report 74 to the client (e.g., user 42 and company 60). In addition to the data provided by the plurality of platform participants (e.g., users 36, 38, 40), other data may be included within analysis project report 74 that is algorithmically generated by analysis process 10. For example, assume that analysis process 10 algorithmically generates an MSRP accordingly to the following illustrative formula:

MSRP=2.20×(manufacturing cost)

The above-defined formula is for illustrative purposes only and is not intended to be a limitation of this disclosure. Specifically, such formulas would tend to be considerably more complex. However, this greatly-simplified formula was provided to allow for an easily understandable example of the concepts of this disclosure. Accordingly and applying the above-stated illustrative formula, analysis process 10 may calculate an MSRP of $39.60 for a manufacturing cost of $18; an MSRP of $41.80 for a manufacturing cost of $19; and an MSRP of $44.00 for a manufacturing cost of $20.

Accordingly, analysis project report 74 may appear as follows:

| Product: | Widget 62 |
|---|---|
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $18 |
| Expert Suggested MSRP: | $40.00 (by user 36) |
| Algorithmically | $39.60 |
| Calculated MSRP: | |
| Manufacturing Cost: | $19 |
| Expert Suggested MSRP: | $45.00 (by user 38) |
| Algorithmically | $41.80 |
| Calculated MSRP: | |
| Manufacturing Cost: | $20 |
| Expert Suggested MSRP: | $43.00 (by user 40) |
| Algorithmically | $44.00 |
| Calculated MSRP: | |

While analysis project report 74 is shown above as being text-based, this is for illustrative purposes only and is not intended to be a limitation of his disclosure, as other configurations are possible. For example, analysis project report 74 may be much more complex in nature and may include graphical components as well as text-based components. Accordingly, analysis project report 74 may include various graphical components, examples of which may include but are not limited to: scatter plots, bar charts, line graphs, and pie charts. Further, analysis project report 74 may be interactive in nature. For example, assume that the plurality of platform participants includes 30 experts (as opposed to 3), wherein each of the three manufacturing costs ($18, $19, $20) was assigned to 10 of these 30 experts. Further assume that analysis project report 74 may be configured to only show the expert-suggested MSRPs associated with a single manufacturing cost (e.g., $18, $19 or $20), wherein analysis process 10 may render a manufacturing cost selection element (e.g., a slider element, push button elements, etc.) that allows the recipient of analysis report 74 to select a manufacturing cost ($18, $19 or $20) so that interactive analysis report 74 may render the 10 MSRPs suggested by the 10 experts assigned to the selected manufacturing cost.

Additionally, analysis process 10 may be configured to adjust its algorithms based upon expert feedback. For example, if (in this example) the MSRPs calculated by analysis process 10 are consistently low when compared to those provided by the experts, analysis process 10 may be configured to adjust its MSRP calculation algorithm so that the calculated MSRPs better track the expert suggested MSRPs.

Analysis process 10 may grade 120 each of the plurality of platform participants (e.g., users 36, 38, 40) based, at least in part, upon their received participant report (e.g., participant reports 68, 70, 72, respectively). For example, analysis process 10 may grade 120 each of users 36, 38, 40 based, at least in part, upon participant reports 68, 70, 72 (respectively) and may provide each of users 36, 38, 40 with a report.

For example, user 36 may receive the following report:

| Participant: | User 36 |
|---|---|
| Product: | Widget 62 |
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $18 |
| Expert Suggested MSRP: | $40.00 (by user 36) |
| Algorithmically | $39.60 |
| Calculated MSRP: | |
| Expert Deviation: | 1.01% (40.00/39.60) |

While user 38 may receive the following report:

| Participant: | User 38 |
|---|---|
| Product: | Widget 62 |
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $19 |
| Expert Suggested MSRP: | $45.00 (by user 38) |
| Algorithmically | $41.80 |
| Calculated MSRP: | |
| Expert Deviation: | 7.65% (45.00/41.80) |

And user 40 may receive the following report:

| Participant: | User 40 |
|---|---|
| Product: | Widget 62 |
| Additional Information: | Mechanical drawings |
| | and 3D models |
| Material: | Machined Aluminum |
| Coating: | Anodized Finish |
| Special Features: | Heat Treated |
| Quantity Sought: | 10,000 |
| Country of Manufacture: | United Stated |
| Manufacturing Cost: | $20 |
| Expert Suggested MSRP: | $43.00 (by user 40) |
| Algorithmically | $44.00 |
| Calculated MSRP: | |
| Expert Deviation: | −2.28% (43.00/44.00) |

Additionally, analysis process 10 may compensate 122 each of the plurality of platform participants (e.g., users 36, 38, 40) based, at least in part, upon their received participant report (e.g., participant reports 68, 70, 72, respectively). As discussed above, a compensation pool may be defined for analysis project 66 that may be paid out to successful participants, wherein the specific compensation received by each successful participant may vary depending upon the quality of their response to analysis project 66. For example, if $1,000 is defined as the compensation pool available to (and split amongst) successful participants, a successful participant may receive (in this example) up to $1,000 (if they are the only successful participant) and may receive a smaller portion of the $1,000 (if they are only partially successful or there are multiple successful participants).

Compensation System

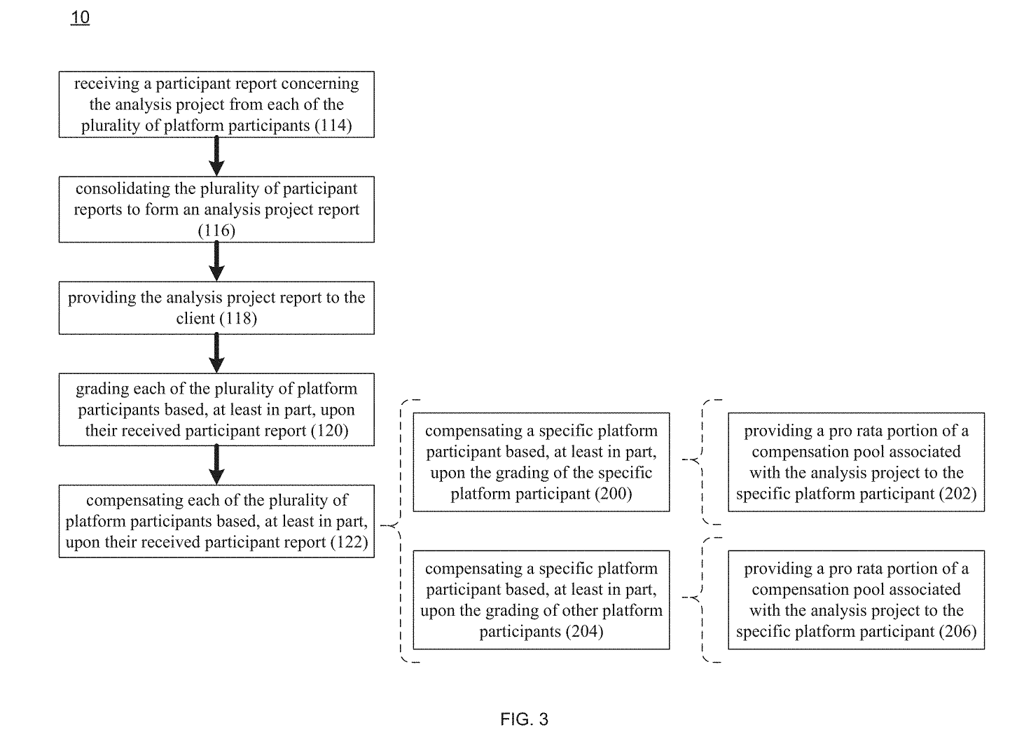

Referring also to FIG. 3 and as discussed above, analysis process 10 may receive 114 a participant report concerning an analysis project (e.g., analysis project 66) from each of a plurality of platform participants (e.g., users 36, 38, 40), thus defining a plurality of participant reports (e.g., participant reports 68, 70, 72); may consolidate 116 the plurality of participant reports (e.g., participant reports 68, 70, 72) to form analysis project report (e.g., analysis project report 74); and may provide 118 the analysis project report (e.g., analysis project report 74) to a client (e.g., user 42 and company 60). Further and as discussed above, analysis process 10 may grade 120 each of the plurality of platform participants (e.g., users 36, 38, 40) based, at least in part, upon their received participant report (e.g., participant reports 68, 70, 72) and may compensate 122 each of the plurality of platform participants (e.g., users 36, 38, 40) based, at least in part, upon their received participant report (e.g., participant reports 68, 70, 72).

When compensating 122 each of the plurality of platform participants (e.g., users 36, 38, 40) based, at least in part, upon their received participant report (e.g., participant reports 68, 70, 72), analysis process 10 may compensate 200 a specific platform participant based, at least in part, upon the grading of the specific platform participant.

For example, analysis process 10 may be configured to compensate 200 a specific platform participant based, at least in part, upon the performance of the specific platform participant. As discussed above, a compensation pool of e.g., $1,000 may be defined for compensating participants of analysis project 66. Further assume that analysis process 10 defines a participant as being successful if their expert deviation is <2.00%. Accordingly and of the three platform participants (e.g., users 36, 38, 40), only one platform participant (e.g., user 36) meets the criteria for being successful. Therefore and in this situation, user 36 may receive $1,000 (or a portion thereof). And if analysis process 10 defines a participant as being successful if their expert deviation is <5.00%, two platform participant (e.g., users 36, 40) meet the criteria for being successful. Accordingly and in this situation, users 36, 40 may each receive $1,000 (or a portion thereof).

Further, when compensating 200 a specific platform participant based, at least in part, upon the grading of the specific platform participant, analysis process 10 may include providing 202 a pro rata portion of a compensation pool associated with the analysis project to the specific platform participant based, at least in part, upon the grading of the specific platform participant.

For example, assume that analysis process 10 defines a participant to be successful according to a sliding scale. For example, if the expert deviation is 0.00%-0.50%, that specific platform participant is 100% successful; if the expert deviation is 0.51%-1.00%, that specific platform participant is 75% successful; if the expert deviation is 1.01%-1.50%, that specific platform participant is 50% successful; if the expert deviation is 1.51%-2.00%, that specific platform participant is 25% successful; and if the expert deviation is >2.00%, that specific platform participant is 0% successful. Accordingly and of the three platform participants (e.g., users 36, 38, 40), only one platform participant (e.g., user 36) meets the criteria for being successful. Accordingly and in this situation, user 36 may receive 50% of the $1,000 compensation pool (or a portion thereof).

When compensating 122 each of the plurality of platform participants (e.g., users 36, 38, 40) based, at least in part, upon their received participant report (e.g., participant reports 68, 70, 72), analysis process 10 may compensate 204 a specific platform participant based, at least in part, upon the grading of other platform participants.

For example, analysis process 10 may be configured to compensate 204 a specific platform participant based, at least in part, upon the performance of the other platform participants. As discussed above, a compensation pool of e.g., $1,000 may be defined for compensating participants of analysis project 66. Further assume that analysis process 10 defines (for this analysis project) a participant to be successful if they are the top two performing experts (regardless of expert deviation). Accordingly and of the three platform participants (e.g., users 36, 38, 40), two platform participants (e.g., user 36, 40) meets the criteria for being successful. Accordingly and in this situation, users 36, 40 may each receive $1,000 (or a portion thereof).

Further, when compensating 204 a specific platform participant based, at least in part, upon the grading of other platform participant, analysis process 10 may provide 206 a pro rata portion of a compensation pool associated with the analysis project to the specific platform participant based, at least in part, upon the grading of other platform participants.

For example, assume that analysis process 10 defines a participant to be successful according to a sliding scale. For example, if the expert deviation is 0.00%-2.00%, that specific platform participant is 100% successful; if the expert deviation is 2.01%-4.00%, that specific platform participant is 75% successful; if the expert deviation is 4.01%-6.00%, that specific platform participant is 50% successful; if the expert deviation is 6.01%-8.00%, that specific platform participant is 25% successful; and if the expert deviation is >8.00%, that specific platform participant is 0% successful. Further assume that analysis process 10 defines (for this analysis project) a participant to be successful if they are the top two performing experts (regardless of expert deviation).

Accordingly and of the three platform participants (e.g., users 36, 38, 40), three participants would be deemed successful according to the percentage scale described above. However and since only the top two participants are deemed by analysis process 10 to be successful, user 36 may receive 100% of the $1,000 compensation pool (or a portion thereof) and user 40 may receive 75% of the $1,000 compensation pool (or a portion thereof).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a participant report concerning an analysis project from each of a plurality of platform participants, thus defining a plurality of participant reports; and
compensating each of the plurality of platform participants based, at least in part, upon their received participant report.

2. The computer-implemented method of claim 1 further comprising:
grading each of the plurality of platform participants based, at least in part, upon their received participant report.

3. The computer-implemented method of claim 2 wherein compensating each of the plurality of platform participants based, at least in part, upon their received participant report includes:
compensating a specific platform participant based, at least in part, upon the grading of the specific platform participant.

4. The computer-implemented method of claim 3 wherein compensating a specific platform participant based, at least in part, upon the grading of the specific platform participant includes:
providing a pro rata portion of a compensation pool associated with the analysis project to the specific platform participant based, at least in part, upon the grading of the specific platform participant.

5. The computer-implemented method of claim 2 wherein compensating each of the plurality of platform participants based, at least in part, upon their received participant report includes:
compensating a specific platform participant based, at least in part, upon the grading of other platform participants.

6. The computer-implemented method of claim 5 wherein compensating a specific platform participant based, at least in part, upon the grading of other platform participant includes:
providing a pro rata portion of a compensation pool associated with the analysis project to the specific platform participant based, at least in part, upon the grading of other platform participants.

7. The computer-implemented method of claim 1 further comprising:
consolidating the plurality of participant reports to form an analysis project report; and
providing the analysis project report to a client.

8. The computer-implemented method of claim 1 wherein the plurality of platform participants includes one or more of:
a plurality of experts;
a plurality of applicants;
a plurality of employees; and
a plurality of candidates.

9. A computer program product residing on a computer readable medium having a plurality of instructions stored thereon which, when executed by a processor, cause the processor to perform operations comprising:
receiving a participant report concerning an analysis project from each of a plurality of platform participants, thus defining a plurality of participant reports; and
compensating each of the plurality of platform participants based, at least in part, upon their received participant report.

10. The computer program product of claim 9 further comprising:
grading each of the plurality of platform participants based, at least in part, upon their received participant report.

11. The computer program product of claim 10 wherein compensating each of the plurality of platform participants based, at least in part, upon their received participant report includes:
compensating a specific platform participant based, at least in part, upon the grading of the specific platform participant.

12. The computer program product of claim 11 wherein compensating a specific platform participant based, at least in part, upon the grading of the specific platform participant includes:
providing a pro rata portion of a compensation pool associated with the analysis project to the specific platform participant based, at least in part, upon the grading of the specific platform participant.

13. The computer program product of claim 10 wherein compensating each of the plurality of platform participants based, at least in part, upon their received participant report includes:
compensating a specific platform participant based, at least in part, upon the grading of other platform participants.

14. The computer program product of claim 13 wherein compensating a specific platform participant based, at least in part, upon the grading of other platform participant includes:
providing a pro rata portion of a compensation pool associated with the analysis project to the specific platform participant based, at least in part, upon the grading of other platform participants.

15. The computer program product of claim 9 further comprising:
consolidating the plurality of participant reports to form an analysis project report; and
providing the analysis project report to a client.

16. The computer program product of claim 9 wherein the plurality of platform participants includes one or more of:
a plurality of experts;
a plurality of applicants;
a plurality of employees; and
a plurality of candidates.

17. A computing system including a processor and memory configured to perform operations comprising:
receiving a participant report concerning an analysis project from each of a plurality of platform participants, thus defining a plurality of participant reports; and
compensating each of the plurality of platform participants based, at least in part, upon their received participant report.

18. The computing system of claim 17 further comprising:
grading each of the plurality of platform participants based, at least in part, upon their received participant report.

19. The computing system of claim 18 wherein compensating each of the plurality of platform participants based, at least in part, upon their received participant report includes:
compensating a specific platform participant based, at least in part, upon the grading of the specific platform participant.

20. The computing system of claim 19 wherein compensating a specific platform participant based, at least in part, upon the grading of the specific platform participant includes:
providing a pro rata portion of a compensation pool associated with the analysis project to the specific platform participant based, at least in part, upon the grading of the specific platform participant.

21. The computing system of claim 18 wherein compensating each of the plurality of platform participants based, at least in part, upon their received participant report includes:
compensating a specific platform participant based, at least in part, upon the grading of other platform participants.

22. The computing system of claim 21 wherein compensating a specific platform participant based, at least in part, upon the grading of other platform participant includes:
providing a pro rata portion of a compensation pool associated with the analysis project to the specific platform participant based, at least in part, upon the grading of other platform participants.

23. The computing system of claim 17 further comprising:
consolidating the plurality of participant reports to form an analysis project report; and
providing the analysis project report to a client.

24. The computing system of claim 17 wherein the plurality of platform participants includes one or more of:
a plurality of experts;
a plurality of applicants;
a plurality of employees; and
a plurality of candidates.
